(19) United States
(12) Patent Application Publication
(10) Pub. No.: US 2009/0076849 A1
(43) Pub. Date: Mar. 19, 2009

(54) Systems and methods for patient-managed medical records and information

(76) Inventor: Kay Diller, Lafayette, CO (US)

Correspondence Address: SHERIDAN ROSS PC, 1560 BROADWAY, SUITE 1200, DENVER, CO, 80202, US

(21) Appl. No.: 11/898,526

(22) Filed: Sep. 13, 2007

(51) Int. Cl. G06Q 50/00

(52) U.S. Cl. 705/3

(57) ABSTRACT

A system and methods for managing a patient's medical records and information that use a portable memory device that securely stores the patient's medical records and information. The portable memory device is formatted for designated access by the patient and third parties, wherein access requires authentication and verification by designated persons in non-emergencies, or by security override in emergency situations. The system and methods for managing a patient's medical records and information can be used at a patient's home, at the patient's physician's office, hospital, or pharmacy, and by emergency response team personnel. The system and methods can use home software designed for use on the patient's home computer or a computer designated by the patient for managing the patient's medical records and information. The patient's physician's office, hospital, or pharmacy, and emergency response team personnel use devices designed to interface with the portable storage device to view, print, and update the patient's medical records and information.

### BACKGROUND OF INVENTION

1. Field of Invention

The invention relates generally to electronic patient medical records management systems and methods.

2. Description of Related Art

In the medical industry, the patient record can be the main tool for diagnosing a patient. It is believed that every year as many as 100,000 people die due to medical errors by highly qualified, skilled and trained physicians and hospitals. Up to 85% of these medical errors result from physicians and hospitals not having the patient's full medical history at the time of treatment. Hospitals and doctors are being urged to convert their patients' hardcopy medical records into an electronic format in an effort to improve health care and save lives.

Support for electronic medical records is becoming wide spread. In July 2005, a Senate committee passed a bill promoting electronic record-keeping, supporting a Presidential executive order mandating The Office of the National Coordinator for Health Information Technology's (ONC) efforts to require that medical records be converted to electronic format, and moving the current conversion rate of 10-15%, to that of 50% within the next eight years.

Further, it is believed that the use of technology through electronic medical records will help doctors provide improved patient care, resulting in reducing errors due to insufficient medical history being available at time of treatment. At present, this burden of converting hardcopy records into electronic records appears to rest solely on physicians and hospitals.

Patients have ownership of their own medical records under the Health Insurance Portability and Accountability Act of 1996 (“HIPAA”). HIPAA allows the patient to request a photocopy or printed copy of their patient information, but the patient does not have the right to change information within the patient's records. If there is a question regarding information within the record, the patient can request comments to be added to the medical record. When the patient requests a copy of their medical record, photocopying or printing costs can become an issue. In most cases, the primary care physician charges the patient a fee for a printed copy or photocopy of their medical record.

With the movement toward electronic medical records and the need of the patient to acquire and manage their medical records, there is a need for a safe and effective patient-managed medical records solution. There is also a need for a cost effective way for the patient to obtain their medical records from a physician or hospital, and a way that the patient can manage their medical records. It is believed that patients can significantly contribute to and benefit from the management of their medical records at a low cost to themselves and to the physicians and hospitals that serve them through the present invention. The present invention discloses a solution for cost-effective, safe and effective patient-managed electronic medical records.

There also remains a need for a system and method of providing patients, physicians, dentists, pharmacists, and emergency personnel/teams with access to medical histories and other medical information. There needs to be an improved method of transmitting and subsequently storing sensitive information for ready-use by an individual and their medical care providers.

### SUMMARY OF INVENTION

The invention provides a patient with a system for managing the patient's sensitive medical records and information. The system utilizes a portable, preformatted Universal Serial Bus flash drive (“USB flash drive”) on which patients can carry their own medical records and information; thus, preferably providing patients, physicians, hospitals, emergency response teams, and pharmacies with immediate access to relevant, and often lifesaving, medical information at the time of treatment. The medical records stored on the flash drive are preferably encrypted to ensure security and to meet the stringent HIPAA privacy requirements. The patient-managed medical records located on the flash drive can be read by the patient using a specially designed software interface, which has security features, that is loaded onto a home computer system. Patients also have the ability to print their medical records using this same system.

The patient-managed medical records stored on the flash drive can be shared with physicians and hospitals that currently use electronic medical records management systems, as well as with those using hardcopy records management systems.

In order to review and approve the sharing of medical records and information with a physicians, hospitals, emergency response teams, and pharmacies, the patient uses the flash drive, a security card and personal identification number (PIN), a security key pad, and a simple Graphical User Interface (“GUI”) located on flash kiosk system or on a hand-held flash drive reader device. Medical records and/or information that the patient approves for sharing with the medical care provider are downloaded from the flash drive into the existing database structure of the physician or hospital via a specially designed database interface. New medical records on physician's or hospital's database can also be downloaded onto flash drive.

Patients, physicians, hospitals, emergency response teams, and pharmacies will preferably have immediate access to critical medical records and information at the time of patient treatment. Updates to the flash drive may be made immediately after the office, hospital, and pharmacy visits for both electronic and hardcopy records management systems. This would include any actions or updates taken or made by emergency response teams.

The preformatted flash drive comprises multiple preformatted data modules with each data module used for storing particular information. For example, one data module will store pharmacy records and can be updated on the flash drive. Another module, the In Case of Emergency (“ICE”) module, will store information related to the patient's emergency contact information. A patient's personal medical information will be stored in another module, wherein such information as allergies to medicines or foods, medical conditions, i.e. diabetes or heart disease, and medical declarations such as Do Not Resuscitate (“DNR”) will be stored in another module.

The flash drive also contains a preformatted module for security overrides, which is not viewable via the GUI. This module allows necessary medical professionals to obtain access to the patient's medical records and information stored on the flash drive should the patient be unable to communicate and/or perform the necessary authentication and security procedures for accessing stored records and information on the preformatted flash drive. Medical professionals will have a separate security override PIN and card.

The present invention provides for a kit comprising necessary components for a patient-managed medical record system and methods of using the kit in the system.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 shows a diagram of an embodiment of a universal flash system including preferred components in accordance with the principles of the invention.

FIG. 2 shows a perspective view of an embodiment of a portable device that has pre-formatted modules and patient medical records in accordance with the principles of an embodiment of the invention.

FIG. 3 shows a preferred embodiment of the portable device and end users in accordance with the principles of the invention.

FIG. 4 shows a diagram of uses for the portable device in accordance with the principles of the invention.

FIG. 5 shows a system for home use of the portable device in accordance with the principles of the invention.

FIG. 6A shows a flow diagram of steps for using the portable device in non-emergency medical record management and outside the home in accordance with the principles of the invention.

FIG. 6B shows a flow diagram of alternative steps for using the portable device in non-emergency medical record management and outside the home in accordance with the principles of the invention.

FIG. 7A shows a flow diagram of steps for using the portable device in emergency medical record access by a patient and/or medical professionals in accordance with the principles of the invention.

FIG. 7B shows a flow diagram of alternative steps for using the portable device in emergency medical record access by medical professionals in accordance with the principles of the invention.

FIG. 8 shows a flow diagram of steps for using the portable device for pharmacy purposes in accordance with the principles of the invention.

FIG. 9 shows a general view of a flash kiosk system in accordance with the principles of the invention.

FIG. 10 shows a general view of a flash kit in accordance with the principles of the invention.

### DETAILED DESCRIPTION OF PREFERRED EMBODIMENTS

The invention is directed to patient-managed medical records and information, including, methods, systems, software, and devices for managing patient medical records in a portable device, preferably, a Universal Serial Bus (USB) flash drive that is adapted to support the creation, storing, accessing, updating, and distributing of the patient's medical records. This provides third parties, such as, the patient's physician(s), hospital(s), emergency response team(s), and pharmacies immediate access to relevant and often lifesaving medical information at the time of treatment. The patient's medical records and information are preferably encrypted on the patient's USB flash drive and require authentication to access particular information contained on the USB flash drive. Thus, in accordance with systems and methods of the invention, patients can carry their own medical records on a small, convenient, portable device called a flash drive, thus providing patients, physicians, hospitals, emergency response teams, and pharmacies, for example, with immediate access to relevant and often lifesaving medical information at the time of treatment or need.

### I. Flash System

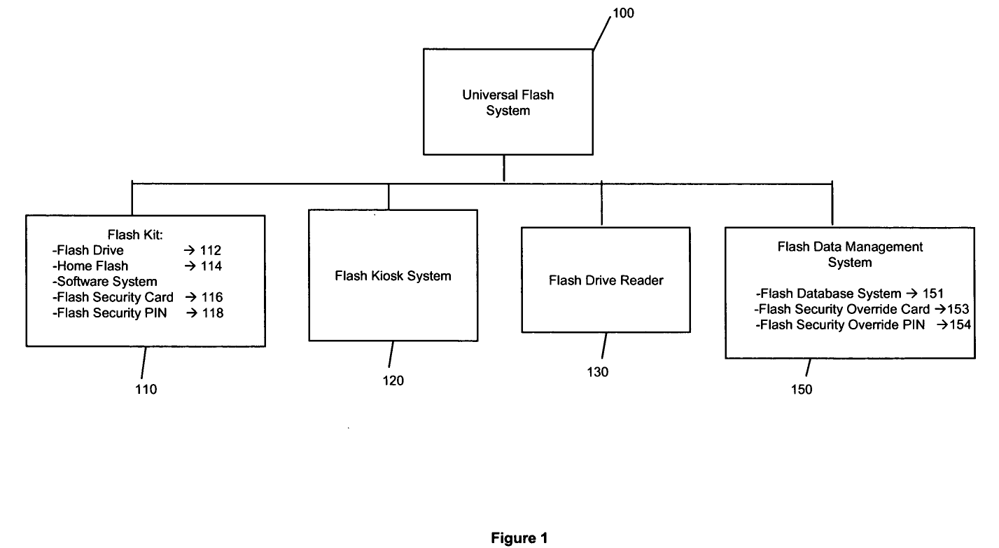

Referring to FIG. 1, a preferred embodiment of a system in accordance with the principles of the invention is shown. As shown in FIG. 1, patient management of medical records can be accomplished through universal flash system 100 in accordance with the principles of the invention. Universal flash system 100 generally may include a flash kit 110, a flash reader 130, flash kiosk system 120, and a flash data management system 150.

A. Flash Kit

Flash kit 110 (see FIG. 10) may preferably include a portable device, preferably flash drive 112, home flash software system 114, flash security card 116, and flash security personal identification number (“flash security PIN”) 118.
1. Flash Drive

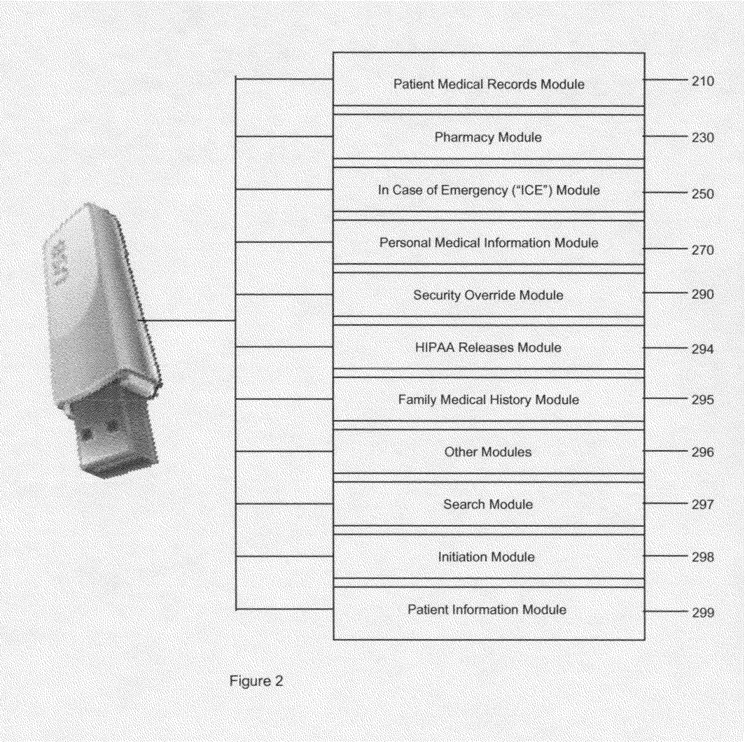

USB flash drive 112 allows patients to carry their medical records in a secure electronic format. USB flash drive 112 is uniquely designed and configured in accordance with the principles of the invention to create, store and manage the patient's electronic medical records and medical information. Accordingly, USB flash drive 112 is preferably preformatted to manage the patient's medical records and information, as will be discussed in a preferred embodiment of the invention with reference to FIG. 2, discussed in more detail later. But, generally, as shown in FIG. 2, USB flash drive 112 preferably includes preformatted modules 210, 230, 250, 270, 290, and 294-299. The modules serve to separate, organize and securely store patient medical records and information, as discussed in more detail later. Preferably, USB flash drive 112 is preformatted with encryption software for secure storage of patient medical records and medical information. Accordingly, the medical records and/or information stored on USB flash drive 112 is preferably encrypted to ensure security and compliance with HIPAA privacy requirements. Universal flash system 100 allows a patient to have more than one flash drive 112 that operate in accordance with the requirements set forth in the present invention.

As a non-limiting example, ICE module 250 may have a preformatted form that the patient completes, wherein the completed information is available for viewing and use by patients, physicians, hospitals, emergency response teams, and pharmacies in times of emergency and/or treatment. Family medical history module 295 may have a preformatted form the patient completes, wherein the completed information is available for viewing and use by patients, physicians, hospitals, emergency response teams, and pharmacies in times of emergency and/or treatment. In another non-limiting example, security override module 290 is preformatted to only allow certain medical providers the ability to view and update flash drive 112 using unique security cards and personal identification numbers, as described herein. The software used with universal flash system 100 is proprietary and for use only with flash drive 112 and universal flash system 100.

USB flash drive 112 can be small in size, for example, two inches long and a half inch wide. The small size allows the patient to carry it conveniently on a key chain, in a pocket or in a purse, for example. USB flash drive 112 can be adapted to interface with a standard USB 2.0 port, for example, found on most computers, flash kiosk system 120, and USB flash drive reader 130 of the instant invention. For example, USB flash drive 112 can be NAND-type flash memory data storage devices integrated with a USB (universal serial bus) interface that are typically small, lightweight, removable and rewritable. NAND (which stands for “Not and”) is a type of flash memory technology that excels at reading, writing and erasing data from flash memory. The memory capacity can vary depending upon the application and patient. For example, USB flash drive 112 can include memory in the range of 32 megabytes and 64 gigabytes; however, one of skill in the art will realize the capacity may be limited only by current flash memory densities, although cost per megabyte may increase rapidly at higher capacities due to the expensive components. Therefore, it should be appreciated that improvements in the technology are anticipated by the present invention. USB flash drive 112 offers potential advantages over other portable storage devices, particularly the floppy disk USB flash drive 112 is more compact, generally faster, holds more data, and is more reliable (due to both the lack of moving parts, and being a more durable design) than floppy disks. USB flash drive 112 typically uses the USB mass storage standard, supported natively by modern operating systems such as Linux, Mac OS X, Unix, and Windows. USB flash drive 112 of the instant invention preferably has a small printed circuit board encased in a plastic or metal casing, making the drive sturdy enough to be carried about in a pocket, for example. It will be appreciated that varying designs of USB flash drive 112 will allow for additional functional aspects, such as the ability to house a flash memory card, for example. Usually, only the USB connector protrudes from this protection, and is usually covered by a removable cap. Typically, USB flash drives 112 use a standard type-A USB connection allowing them to be connected directly to a port on a personal computer or laptop, for example.

USB flash drive 112 is adapted so it can be connected to a computer. For example, USB flash drive 112 can be connected to a computer, flash kiosk system 120, flash drive reader 130 or other devices either by plugging it into a USB host controller built into the computer, or into USB flash drive reader 130, for example. USB flash drives 112 are typically active only when plugged into a USB connection and draw all necessary power from the supply provided by that connection. However, some USB flash drives 112, especially high-speed USB flash drives 112 utilizing the USB 2.0 standard, may require more power than the limited amount provided by a bus-powered USB hub, such as those built into some computer keyboards or monitors, for example.

USB flash drive 112 preferably includes encryption of the data stored on it, generally using full disk encryption below the file system. This prevents an unauthorized person from accessing the data stored on it, thus, exceeding HIPAA requirements. The encryption is to be state of the art and may be approved by HIPAA board. Encryption is critical to all medical information stored on flash drive 112. The encrypted data can be decrypted via the syncing up of the CDROM software from home flash software system 114 at home, or by flash security card 116 and flash security PIN 118 at locations outside the home. USB flash drive 112 is accessible only in the minority of computers, flash kiosk system 120, or USB flash drive readers 130, which have compatible encryption software, for which a portable standard is deployed. As a non-limiting example, flash drive reader 130 can decrypt the data on flash drive 112 through use of flash security card 116 and flash security PIN 118. The encryption is intended to prevent unauthorized parties from gaining access to flash drive 112 when, for example, flash drive 112 is lost or misplaced. Executable files can be stored on USB flash drive 112, together with the encrypted file image. The encrypted partition can be accessed on any computer running, for example, Microsoft Windows. USB flash drive 112 of the instant invention may allow the user to configure secure and public partitions of different sizes. As a non-limiting example, the user may partition a desired portion of the available memory of USB flash drive 112 for non-secured, non-encrypted data storage, while the remaining preformatted portion of the memory on USB flash drive 112 is partitioned for managing and storing the user's secured and encrypted medical records and medical information within the meaning of the instant invention. Executable files for Windows, Macintosh, and Linux may be on the drive, depending on manufacturer support. Some security software may require administrative rights on the host computer, for example, to access data. USB flash drive 112 can further support biometric fingerprinting, for example, to confirm the user's identity.
2. Home Flash Software System

Flash kit 110 further preferably includes home flash software system 114 that that is loaded and resides on the patient's home computer system and is interoperable with USB flash drive 112. Home flash software system 114 can extract the patient's encrypted medical records and patient information from USB flash drive 112, so the patient can review and print the created, stored, new and/or updated medical records and information added by, shared with or received from a patient, physician, hospital and/or pharmacy. Home flash software system 114 requires authentication by the patient, as described herein. The patient preferably acquires flash kit 110 through prescription or from over the counter purchase (FIG. 10). Home flash software system 114 of flash kit 110 preferably includes CD-ROM software and instructions (FIG. 10). After loading the CD-ROM, the patient inserts flash drive 112 into the home computer system. The patient is then prompted to initiate flash drive 112, and activate the security features on CD-ROM software. The patient creates a login, including name/ID with personal identification number (PIN, while flash drive 112 is inserted in the home computer system. Flash drive 112 is dynamically updated with each login and PIN, in accordance with the present invention. This process preferably applies for multiple flash drives 112 if the patient chooses to obtain more than one flash drive 112 for use through the patient's prescription for or over counter purchase of universal flash system 100. At this time or a later time, the patient may enter such information as ICE module 250 information, family medical history module 295 information, and current medications (to be updated after first pharmacy visit with syncing), personal medical information module 270 information, patient information module 299 (address, date of birth, next of kin, etc . . . ). The modules will be constantly updated as needed to add such events as address changes, changes in insurance, etc . . . . The patient can update or have physician's office or hospital assist with keeping information current.

As discussed, universal flash system 100 allows a patient to have multiple flash drives 112. In situations where the patient has more than one flash drive 112, each can be linked via CD-ROM in home flash software system 114 (FIG. 10). This allows the patient to have and manage many flash drives 112 with one flash security card 116 and one flash security PIN 118, described herein.
3. Flash Security Card

Flash kit 110 preferably includes a flash security card 116 used by the patient at a physician's office, hospital, or pharmacy, and by ERT staff. Flash security card 116 is swiped through an appropriate portion of flash kiosk system 120 or through flash drive reader 130 for authentication and security purposes in accordance with the present invention. Flash security card 116 can ensure security and authentication when viewing or sharing the patient's medical records and patient information outside of the home environment and to meet HIPAA privacy compliance guidelines.
4. Flash Security PIN

Flash kit 110 preferably includes flash security PIN 118. Flash security PIN 118 can be used by the patient to access and view medical records and patient information at home that are stored on USB flash drive 112. Flash security PIN 118 can also be used for authentication and access to USB flash drive 112 encrypted data for viewing and sharing medical records and patient information at a physician's office, hospital or pharmacy, for example. After a patient inserts flash drive 112 into kiosk system 120 and swipes flash security card 116, the patient is prompted to enter flash security PIN 118. The patient can use GUI or keyboard to enter flash security PIN 118. Flash security PIN 118 is also used on home computer to gain access to medical records and information. For pharmacy use, flash security PIN 118 is used to allow syncing of medicine information on flash drive reader 130. This additional security step can also support HIPAA privacy compliance.
5. First Time Use of Universal Flash System 100 at Home

A patient can preferably load home flash software system 114 on the patient's preferred computer (laptop or personal computer) by inserting flash drive 112 and the CD-ROM with the software, and initiating download procedures. The initiation screen walks the patient through modules that are mandatory. For example, the process will require the patient to address HIPAA releases module 294 (FIG. 2), and security override module 290 (FIG. 2) in accordance with the present invention. It is here that the patient sets preferences regarding HIPAA and emergency override access to modules on flash drive 112 in emergency situations. Therefore, the patient can either provide HIPAA releases thereby giving medical professionals access to medical records and information on flash drive 112 in emergency situations, or the patient can deny such access depending on the preferences chosen by the patient in the mandatory portions of initiation procedures at installation of home flash software system 114. The patient will also be prompted to complete forms in recommended modules, such as family medical history module 295, patient information module 299, and personal medical information module 270. The patient may bypass the recommended modules after setting up login information, such as flash security PIN 118, and completing required fields. All of these options are presented to the patient via a graphics user interface (GUI) in accordance with the present invention.

Subsequent uses of flash drive 112 at home will require insertion of flash drive 112 into the patient's preferred computer with home flash software system installed thereon. The patient will then be prompted on GUI to login with flash security PIN 118. At that time the patient will be presented with a list of modules to choose. Each module can preferably allow the patient to move to other modules, and preferably prompts the patient to save or not save changes in the module before moving to next module.

B. Flash Drive Reader

USB flash drive reader 130 is a reader that is interoperable with flash drive 112. USB flash drive reader 130 preferably includes a hardware device with proprietary software for use with universal flash system 100 used by physicians, hospitals and ERTs generally during emergencies. Flash drive reader 130 preferably allows interfacing with medical application databases. It should be noted that some flash drive readers 130 may serve as read only devices while other flash drives 130 may permit full interaction with universal flash system 100, such as syncing of medical records and information. Therefore, flash drive readers 130 may allow uploading or downloading of data to be shared on or with flash drive 112; however, some flash drive readers 130 may be read only and not allowing for syncing of medical information, such as in certain medical emergencies. This process is designed to allow quick access to medical records and information on flash drive 112. The software used on flash drive reader 130 allows the viewing of desired data as based on the roles of party accessing flash drive 112 as described herein below.

In use, the medical professionals (i.e., emergency personnel insert the patient's USB flash drive 112 into USB flash drive reader 130, then “swipes” their flash security override card 153 through the flash reader and enters their flash security override PIN 154 on a keypad when prompted to do so. If the patient authorized HIPAA release and medical personnel access in the initiation procedures while installing home flash software system 114, then USB flash drive reader 130 authenticates the emergency personnel and allows viewing access to medical records and patient information stored on USB flash drive 112. Once access is given, the GUI will show all modules available for access, and will preferably permit easy navigation to and from necessary modules on flash drive 112 in a read only format. If the patient's preferences in the initiation process were to deny HIPAA release and access to emergency personnel, then flash drive reader 130 will preferably deny access to medical records and information on flash drive 112.

Flash drive reader 130 can be a desktop unit or portable. For example, Emergency Response Teams (“ERTs”) can carry a hand-held version of flash drive reader 130 to be used during medical emergencies and while transporting patients in ambulances. In the event that a patient is unable to access their flash security card 116 and their flash security PIN 118, ERTs, physicians, and hospitals can have a security override, as described herein, allowing them to access records located on USB flash drive 112 during a medical emergency. USB flash drive reader 130 may also be used to display the records and information contained on USB flash drive 112, either through a graphical user interface (“GUI”) on USB flash drive reader 130 or through attachment of USB flash drive reader 130 to a laptop computer or personal computer for easier viewing with GUI described herein.

C. Flash Data Management System

Universal flash system 100 preferably includes flash data management system 150. Flash data management system 150 can preferably have flash database system 151, flash security override card 153, and flash security override PIN 154. Flash database system 151 permits comparisons and/or syncing of medical records and information between flash drive 112, the flash data management system 150, and physicians', hospitals', and pharmacies' application databases.

In emergency situations, as discussed in more detail herein, physician's and/or hospitals' may be required to override security protocols on flash drive 112 to obtain a patient's medical records and information. In such situations, a physician or hospital participating within universal flash system 100 would use flash security override module 290 (described below) to override security protocol on flash drive 112. This is preferably achieved when the physician, hospital or ERT swipes their flash security override card 153 and enters their flash security override PIN 154; thereby initiating access to necessary medical records and information.

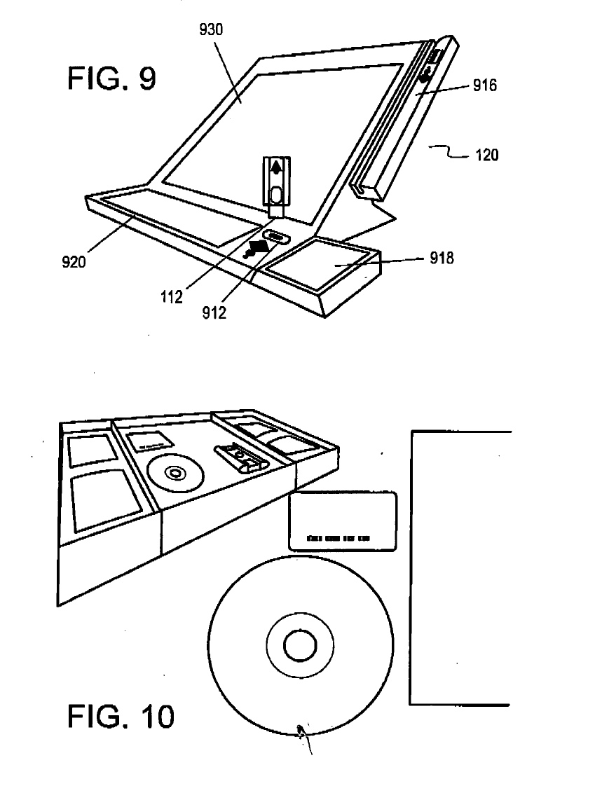

Flash data management system 150 is preferably designed to allow interfacing with medical application databases for comparison of data from medical application databases, flash drive 112 data and flash data management system 150 data. Flash data management system 150 is a database that is used solely with universal flash system 100. Here, the data is from application databases that are not available on doctor's or physician's systems. As a non-limiting example, a dermatologist would have different software applications and databases than an oncologist, but data may need to be shared between the two doctors. Also, this database can store scanned images or a new database can be created. After authentication is completed, the patient's encrypted medical records stored on flash drive 112 can be extracted and then compared against current electronic medical records and digitized hardcopy medical records in medical application databases and flash data management system 150. The database systems, as described herein, can preferably allow scanning of hardcopy records and sharing of scanned hardcopy records via a temporary file. Any record not already in the physician or hospital database is presented to the patient. Preferably, this information can be presented to the patient for viewing via a GUI on flash kiosk system 120 (FIG. 9), although other types of user interfaces can be used. The GUI can function as a type of user interface that allows people to interact with a computer and computer-controlled devices which employ graphical icons, visual indicators or special graphical elements, along with text labels or text navigation to represent the information and actions available to a user. The actions are usually performed through direct manipulation of the graphical elements. Furthermore, the data to be compared can be done so via document comparison software. One of skill in the art will appreciate the type(s) of GUI to be utilized with universal flash system 100 of the present invention.

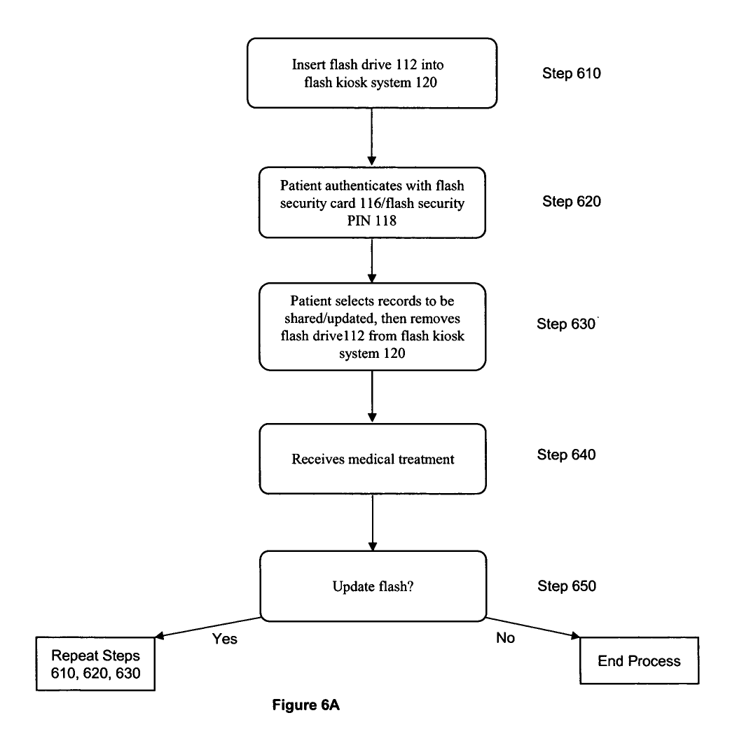

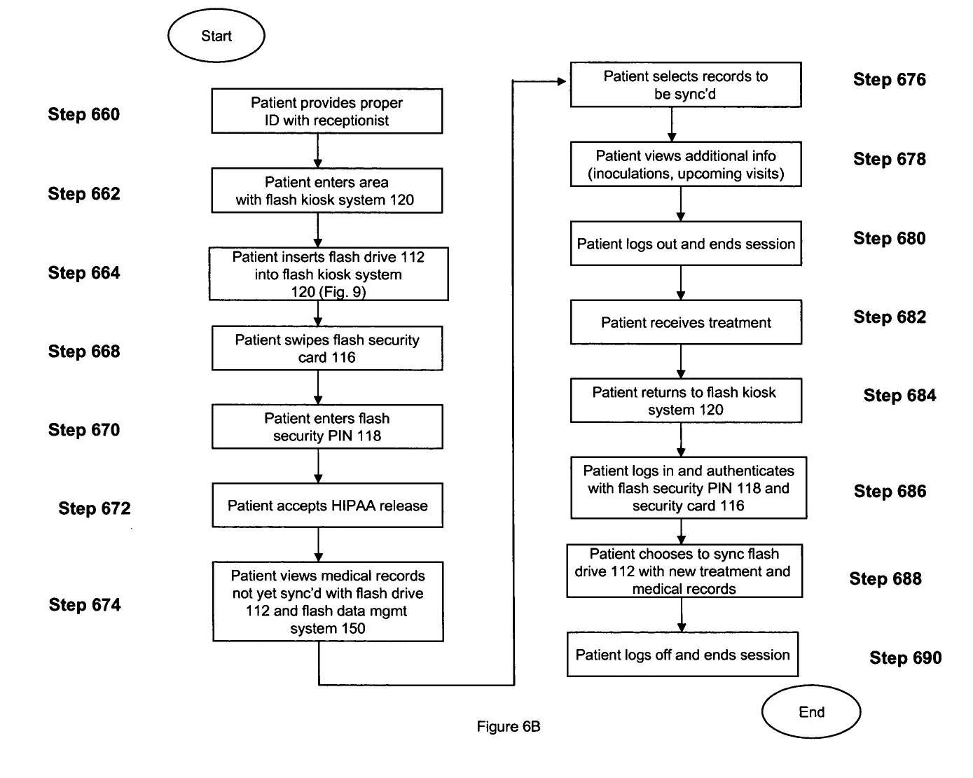

Flash data management system 150 compares data on all three databases and creates a temporary file of differences. This temporary file is displayed on flash kiosk system 120 and the process used is as followed for non-emergency uses 430 in FIG. 6. GUI features may offer both “touch” features on the screen, as well as data entry via a keypad or keyboard. GUI will allow patients to move among modules and view limited data, along with full medical records data. GUI may be linked to physicians and hospital applications that have reminders of appointments, needed inoculations, interesting medical alerts, for examples. This information may be on a separate screen as well as placed on other screens, such as “home” screen.

Of those records not already in the physician or hospital database, the patient can decide what records, if any, they want to share with the physician or hospital, and the records are then downloaded into the physician or hospital database structure via flash data management system 150. The physician or hospital can immediately view or print the downloaded records. Electronic records can be stored electronically in data fields. Data fields are part of database schema and can use conventional methods for record storage. Hardcopy records may not be stored electronically by data fields. Therefore, hardcopy records can be scanned and stored as attachments on USB flash drive 112 and physician or hospital databases. The files can be attached in any standard format including Portable Document Format (“PDF”). PDFs may be encrypted so that a password is needed, for example, for access and stored on USB flash drive 112 as encrypted medical records and patient information. Therefore, no additional security/authentication measures are required beyond those described herein. Thus, it will be understood that particular data (such as PDF attachments) can be stored as read-only files, images or documents in accordance with the principles of the invention. The read-only stored records, files, images or documents may be from the patient, physician, hospital, and/or pharmacy, for example.

D. Flash Kiosk System

Flash kiosk system 120 (FIG. 9) is used by the patient away from the home. Flash kiosk system 120 is preferably located in a physician's office or a hospital. Flash kiosk system 120 is also preferably housed in a private area and only accessed once proper identification is shown to a receptionist or other personnel responsible for oversight of flash kiosk system 120; however, the handling of access to flash kiosk system 120 is to be determined by those parties housing the system.

Once the patient is given access to flash kiosk system 120, the patient inserts flash drive 112 and uses flash security card 116 and flash security PIN 118 to authenticate and initiate medical records management via flash kiosk system 120. Steps taken by a patient at kiosk system 120 are discussed generally in FIG. 6A. In a non-limiting alternative approach, a patient may perform the steps illustrated in FIG. 6B.

Flash kiosk system 120 preferably works with physicians' and hospitals' application databases, flash drive 112, and flash data management system 150 for medical records comparisons as described herein. Flash kiosk system 120 allows for full service comparison of patient's records on flash drive 112, records on flash data management system 150, and physician's or hospital's application databases. Flash kiosk system 120 may allow a patient to, but not limited to, upload/download records, add information (allergies, etc . . . ), receive alerts (i.e., from doctors and hospitals), initiate flash drive, tutorials (i.e., how to use), and auto time-out features.

Flash kiosk system 120 preferably has USB port 912 for receiving flash drive 112 when inserted by the patient. Flash kiosk system 120 preferably has security card swipe 916 that allows the patient to swipe security flash card 116; thus, allowing the patient to initiate authentication. Flash kiosk system 120 may also have keypad 918 that allows the patient to input flash security PIN 118; thus, finalizing the authentication process. Flash kiosk system 120 also has keyboard 920 for input of information regarding commands for execution of software interface, or for data entry, for example. As described herein, flash kiosk system 120 has a GUI 930 that permits the patient to view documents for comparisons.

When a patient uses flash kiosk system 120 (FIG. 9) for the first time, the patient is preferably provided with an optional tutorial as to how to interact with and exchange information between flash drive 112 and flash kiosk system 120. The patient inserts flash drive 112 into USB port 912. GUI 930 will display an option for a tutorial. If the patient opts to take the tutorial, the patient will preferably be taken to an initiation screen upon completion of tutorial. If the patient opts not to take the tutorial, then the patient will preferably be taken to an initiation screen. The initiation screen on GUI 930 will guide the patient through the steps to initiate flash drive 112 with flash security card 116 and flash security PIN 118. Once the initial guidance is completed, the patient can interact with flash kiosk system 120 in accordance with the present invention. Anytime the patient uses flash kiosk system 120 thereafter, the patient can preferably insert flash drive 112, swipe flash security card 116, and enter flash security PIN 118. At that point, the patient can preferably upload, download, view, and update (sync) medical records and information, for example. GUI 930 preferably lists all modules to choose, wherein each module allows patient to move to other modules easily, while giving the patient the opportunity to save any changes made to any module before moving to another module of interest.

### II. Flash Drive Modules

USB flash drive 112 is preferably preformatted for creating, storing, organizing and accessing patient medical records and information. Referring again to FIG. 2, briefly discussed above, USB flash drive 112 preferably includes patient medical records module 210, pharmacy module 230, In Case of Emergency (“ICE”) module 250, personal medical information module 270, and security override module 290 (wherein the user has own PIN 291 and card 292), HIPAA releases module 294, family medical history module 295, other modules 296, search module 297, initiation module 298, and patient information module 299. These preformatted modules separate and securely store particular patient medical records and information. Preferably the medical records and information in the modules are encrypted. The modules can have different functionalities, purposes and/or accessibility by third parties. For example, all non-security override modules are preferably accessible by the patient, and some modules may be only accessible to certain third parties depending on the party's roles as described herein.

Tables 1-4 illustrate examples of roles taken by the patient, physicians, ERT, hospitals and pharmacies. As shown in Tables 1-4, the role of a particular party varies regarding the data modules on flash drive 112. As illustrated, a role may include full, limited, or no access to a module or modules for read (R), write (W), edit (E), read only, and search capabilities. Once a role is authenticated by a party, then the party has access to all modules pertaining to that particular role of the party; thus, there are preferably no individual module logins.

Table 1 illustrates non-limiting examples of the roles of parties regarding patient medical records module 210. As is made clear, the roles of the parties involved vary with regards to the records of interest. Patient medical records module 210 may possess records from physicians and/or hospital, and records from the patient. Table 1 illustrates by way of example as to how each type of record would be managed depending on the role of the party involved.

TABLE 1

| | Patient Med. Rec. Module | Patient Med. Rec. |
|---|---|---|
| | 210 (rec. from physician | Module 210 |
| Party | and/or hospital) | (rec. from patient) |
| Patient | Read only | R, W, E |
| Physician | R, W, E | R, W, E |
| ERT | Read only | Read only |
| Hospital | R, W, E | R, W, E |
| Pharmacy | None | None |

Table 2 illustrates other non-limiting examples of roles regarding pharmacy module 230, ICE module 250 and personal medical information module 270. Again, roles can vary with regards to the different modules contained on flash drive 112.

TABLE 2

| | | ICE | Personal Med. Rec. |
|---|---|---|---|
| Party | Pharmacy Module 230 | Module 250 | Info. Module 270 |
| Patient | Read only (from | R, W, E | R, W, E |
| | Pharmacy) | | |
| | R, W, E (for Patient | | |
| | entered rec.) | | |
| Physician | Read only (for above) | R, W, E | R, W, E |
| | R, W, E for new | | |
| | information and | | |
| | prescriptions | | |
| ERT | Read only | Read only | Read only |
| Hospital | Same as for physician | R, W, E | R, W, E |
| Pharmacy | R, W, E | R, W, E | R, W, E |

Table 3 shows non-limiting examples of roles regarding security override module 270, family medical history module 295, and search module 297. Each party's role with regards to each module may vary.

TABLE 3

| | Security Override | Family Med. History | Search |
|---|---|---|---|
| Party | Module 270 | Module 295 | Module 297 |
| Patient | No access | R, W, E | Can search |
| Physician | R, W, E with sec. | R, W, E | Can search |
| | override card 153 and | | |
| | PIN 154 | | |
| ERT | Same as physician | Read only | Can search |
| Hospital | Same as physician | R, W, E | Can search |
| Pharmacy | Same as physician | Read only | Can search |

Table 4 illustrates other preferred non-limiting examples of roles taken by parties involved in universal flash system 100. Table 4 shows the roles as they may pertain to flash drive initiation module 298, HIPAA releases module 294, and patient information module 299.

TABLE 4

| | Flash Drive | | |
|---|---|---|---|
| | Initiation | HIPAA Releases | Patient Information |
| Party | Module 298 | Module 294 | Module 299 |
| Patient | R, W, E | R, W, E | R, W, E |
| Physician | R, W, E | R, W, E | R, W, E |
| ERT | No access | Read only | Read only |
| Hospital | R, W, E | R, W, E | R, W, E |
| Pharmacy | R, W, E | R, W, E | R, W, E |

The present invention preferably allows a physician and/or pharmacy to initiate flash drive 112 for patients who do not have computers at home. Pharmacies will be limited to data that is input during initiation and will relate to medicines and prescriptions, for example. Patients will have to use flash kiosk system 120 to complete family medical history module 295, personal medical information module 270, and patient information module 299, for example.

Patient medical records module 210 can receive and store patient medical records, share stored medical records not presently in a physician or hospital database, and for the patient to view the records for accuracy and self-knowledge in the privacy of the patient's home. Records stored within patient medical records module 210 are preferably encrypted. Scanned hardcopy records can be stored in this module or stored in a separate module. See Table 1 for roles involving patient medical records module 210.

Pharmacy module 230 preferably can store patient records and information pertaining to prescription drugs, other medicines, and medical devices. These records and information can be stored and made available to patients, pharmacies, physicians, hospitals and ERTs through pharmacy module 230 preformatted on USB flash drive 112. Furthermore, pharmacy module 230 may preferably be synced automatically upon authentication. If pharmacy module 230 is automatically synced, then universal flash system 100 may preferably aid in preventing fraud with regards to multiple prescriptions used in conjunction with multiple pharmacies. Alternatively, fraud may be preferably prevented by having automatic syncing in combination with not having a flash kiosk system 120 located at the pharmacy.

Pharmacists can review the information in pharmacy module 230 before filling a prescription to determine whether there may be any contraindications with the introduction of a new prescription drug or possible negative interactions with existing prescriptions or medicines not already in their database. Additionally, any records generated by the pharmacy may be added to USB flash drive 112, if the records are not present on USB flash drive 112. See Table 2 for roles involving pharmacy module 230.

In Case of Emergency (“ICE”) module 250 is an emergency contact module on USB flash drive 112. This module preferably allows physicians, hospital emergency staff, ERTs, and pharmacies to obtain access to the patient's emergency contacts stored on the USB flash drive 112. Physicians, hospital emergency staff, ERTs and pharmacies can access ICE module 250 in emergency situations where the patient is unable to communicate or complete the necessary authentication procedures using flash security card 116 and flash security PIN 118. This emergency access to ICE module 250 or any other module is gained through emergency security override module 290, described herein, on USB flash drive 112. See Table 2 for roles involving ICE module 250.

Personal medical information module 270 can include information on the patient's medical history such as allergies to medicines or foods, medical conditions such as diabetes or heart disease, and medical declarations such as living wills and do not resuscitate (“DNR”). This module may also list persons authorized to manage the patient's medical affairs during emergencies and times of incapacitation. Personal medical information module 270 can be accessed by patient authentication as described herein, or through security override module 290, described herein, in emergency situations where the patient cannot authenticate for access to USB flash drive 112.

Security override module 290 can include an emergency security override on USB flash drive 112, for use in emergencies only. Security override module 290 allows physicians, hospital emergency staff, ERTs and pharmacies to obtain access to the particular medical records and information modules stored on USB flash drive 112, as illustrated in Tables 1-4, should the patient be unable to communicate and/or perform the necessary authentication and security procedures described herein. As shown in Table 3, security override module 290 requires the party, other than the patient, in that role to use flash security override card 153 and flash security override PIN 154 to gain access to modules for those particular roles that would apply to the emergency and party accessing.

HIPAA releases module 294 can preferably be used during flash drive 112 initiations at any location where flash drive 112 is to be used. Upon initiation, HIPAA releases module 294 will prompt the party in a particular role to give or acquire approval for accessing flash drive 112. As a non-limiting example, if the patient did not wish to consent to the party accessing flash drive 112 via security override module 290, then the party would not have access to information on flash drive 112. Therefore, if during initiation, the patient releases consent for all emergencies, or refrains from giving consent, HIPAA requirements are satisfied. See Table 4 for roles involving HIPAA releases module 294.

Family medical history module 295 can preferably contain standard information collected by medical and healthcare professionals. This information may be entered upon initiation of flash drive 112 or entered/completed at a later time by patient, physician or hospital.

Other module 296 may preferably be established to create, edit and share information that does not belong in other data modules on flash drive 112.

Search module 297 uses conventional search engines, and will preferably allow all parties to quickly locate particulate data of interest. See Table 3 for roles involving search module 297.

Flash drive Initiation module 298 is activated when first using flash drive 112 and home flash software system 114. It is mandatory that HIPAA and security override information be completed upon initiation; thus, providing required release of medical records and information in times of emergencies as covered under HIPAA. It is recommended that family history, personal medical information and patient information be entered into respective modules at the time of initiation.

Patient information module 299 is preferably used to show such information as full legal name, current address, and health insurance, for example.

### III. Universal Flash System Usage

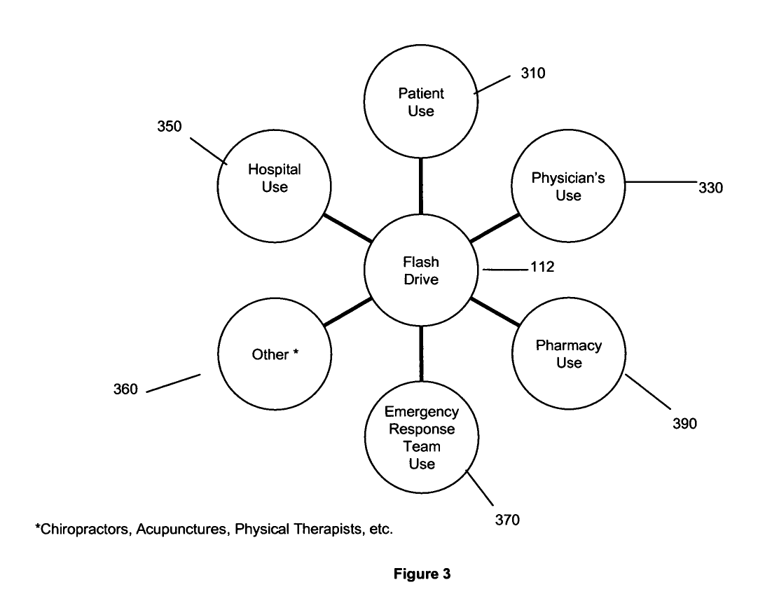

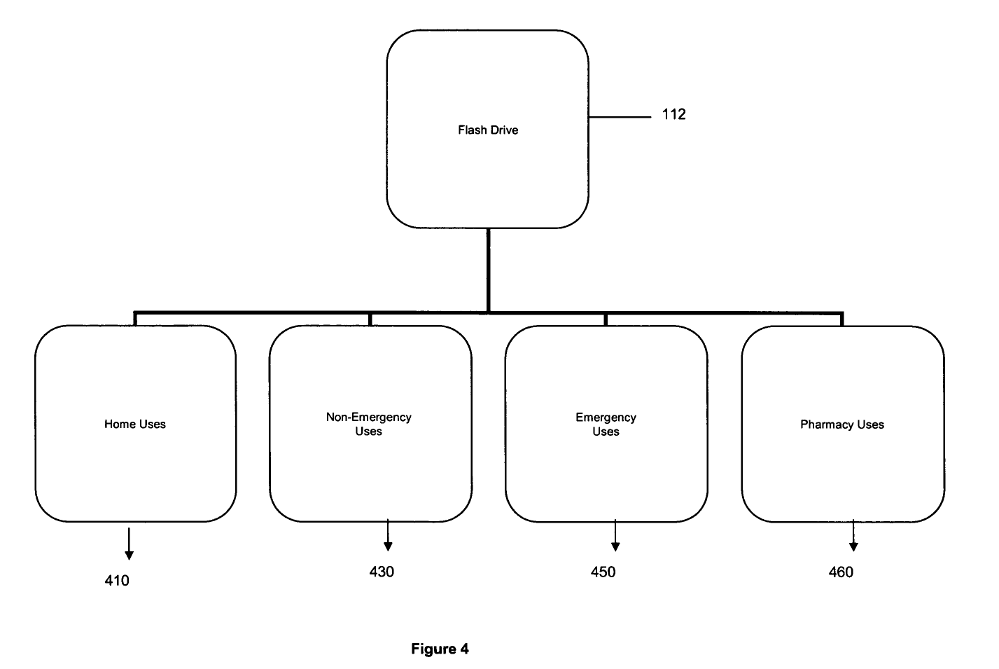

Referring now to FIG. 3, several preferred locations for using USB flash drive 112 within universal flash system 100 are shown. Other uses beyond those disclosed can be included in accordance with the principles of the invention. For example, flash drive 112 could be used with dentists and dental records, laboratories, chiropractors, acupuncturists, physical therapists, psychologists, psychiatrists and/or other types of patient care. Furthermore, the system can include family medical histories, wherein the systems and methods can be implemented across a family. FIG. 4 illustrates preferred uses of USB flash drive 112 within universal flash system 100. Home uses 410 allow the patient to review their records and information for accuracy and completeness at their location of choice, typically their home. Non-emergency uses 430 can be outside the patient's home and generally in physician offices, and hospitals, for example. Emergency uses 450 are in response to emergency situations where the individual patient is in need of emergency attention and treatment. Pharmacy uses 460 are also non-emergency and are discussed in more detail herein. Physicians, hospital emergency staff and ERTs are examples of third parties that may use USB flash drive 112 in emergency situations. As discussed above, other uses are contemplated.

An exemplary chart of preferred components and preferred end uses in accordance with an embodiment of universal flash system 100 is shown below in Table 5.

TABLE 5

| Components | End-Users |
|---|---|
| Flash Kit | Patient |
| Flash Drive | |
| Flash Home Software System | |
| Flash Security Card | |
| Flash Security PIN | |
| Flash Reader | Physician, Hospital, ERT and |
| | Pharmacy |
| Flash Data Management System | Physician and Hospital |
| Patient Medical Records Module | Patient, Physician, Hospital, |
| | and ERT |
| Pharmacy Module | Pharmacy |
| In Case of Emergency (“ICE”) Module | Patient, Physician, Hospital, |
| | ERT and Pharmacy |
| Personal Medical Information Module | Patient, Physician, Hospital, |
| | ERT and Pharmacy |
| Security Override Module | Hospital Emergency Staff and |
| | ERT |

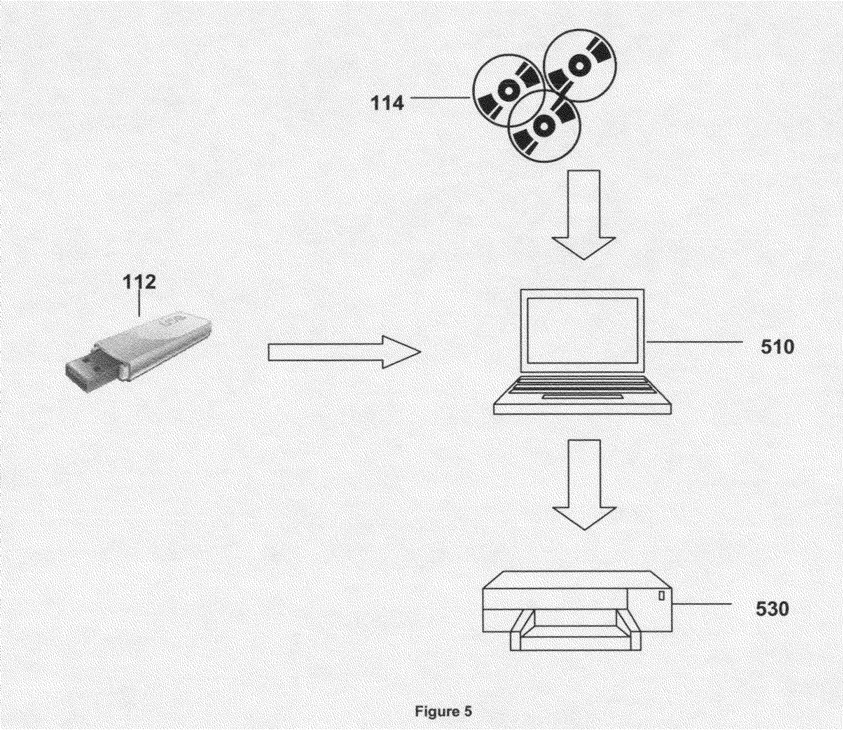

An exemplary system for home uses 410 is illustrated in FIG. 5, which can allow the individual patient to use USB flash drive 112 to review their records and information for accuracy and completeness in their home, for example. The individual patient loads home flash software system 114 onto home computer 510. Home computer 510 can be any computer that is capable of operating home flash software 114, interfacing with USB flash drive 112, displaying records and information stored on USB flash drive 112, and printing of records and information, as desired by the patient, on printer 530. Once home flash software system 114 is working on the patient's home computer 510, USB flash drive 112 can be inserted into home computer 510. Home flash software system 114 will prompt the individual patient to enter flash security PIN 118 in order to access USB flash drive 112. Back end security uses CDROM of home flash software system 114, whereby the CDROM verifies flash drive 112. Flash drive 112 can be viewed without the CDROM being loaded; however, the patient cannot access data on flash drive. Once accessed, the records and information on USB flash drive 112 can be viewed on home computer 510. Once records and information are displayed on home computer 510, the individual patient can review the records and information for accuracy and completeness, and optionally print selected records and/or information on printer 530. Commercially available computers and/or printers can be used in accordance with the principles of the invention in order to support home flash software system 114 and USB flash drive 112.

### VI. Applications for Use

Referring to FIG. 6A, steps of a preferred embodiment of non-emergency uses 430 are illustrated. To begin, step 610 requires the patient to insert USB flash drive 112 into flash kiosk system 120 via USB port 912. Then, an authentication step 620 occurs to view the medical records on the USB flash drive 112. To authenticate, the patient preferably swipes flash security card 116 through flash security card swipe 916, and then enters flash security PIN 118 on keypad 918. Once authentication is complete, the records and information on USB flash drive 112 can be viewed via a GUI 930. Medical records on the USB flash drive 112, but not already in the physician, hospital or pharmacy databases can be displayed to the patient via GUI 930. Medical records not already on the patient's USB flash drive 112 can be displayed to the patient via GUI 930. Then, the patient can select medical records and information to be shared, or records to sync with physician's or hospital's applications databases, as illustrated in step 630, for example those on USB flash drive 112 to share or sync with the physician, hospital or pharmacy database or those to be downloaded from the physician, hospital or pharmacy database to the patient's USB flash drive 112. This selection in step 630 can occur through GUI 930. Once sharing is completed or decision not to share has been made, USB flash drive 112 can be removed from flash kiosk system 120 in step 630. The patient then receives medical treatment or consultation in step 640. After the patient receives treatment, the patient has the opportunity to update USB flash drive 112 in step 650. If it is determined that no medical records are to be added to USB flash drive 112, then the patient can end the process. If USB flash drive 112 requires updating or additional access is desired then the patient can repeat steps 610, 620 and 630 and, when finished, can end the process.

In an alternative embodiment, non-emergency use 430 is illustrated in FIG. 6B. In step 660, the patient provides proper identification to receptionist or other personnel responsible for oversight of flash kiosk system 120, whereupon the patient is allowed to enter the area of flash kiosk 120 (step 662). Patient inserts flash drive 112 into flash kiosk system 120 (step 664) and authenticates in steps 668 and 670. After step 670, the patient is prompted to accept HIPAA releases (step 672). Upon acceptance of HIPAA releases, the patient views medical records not yet sync'd with flash drive 112 and flash drive data management system 150 (step 674). In step 676, the patient selects the records to sync, and views any additional information, such as inoculations, upcoming visits, or alerts, for example (step 678). Once complete, the patient logs out and ends the session (step 680). The patient then receives treatment or consultation (step 682) and returns to flash kiosk system 120 (step 684). The patient then authenticates (step 686) and chooses those records to sync regarding the treatment or consultation (step 688). Once this is done, the patient logs off and ends the session (step 690).

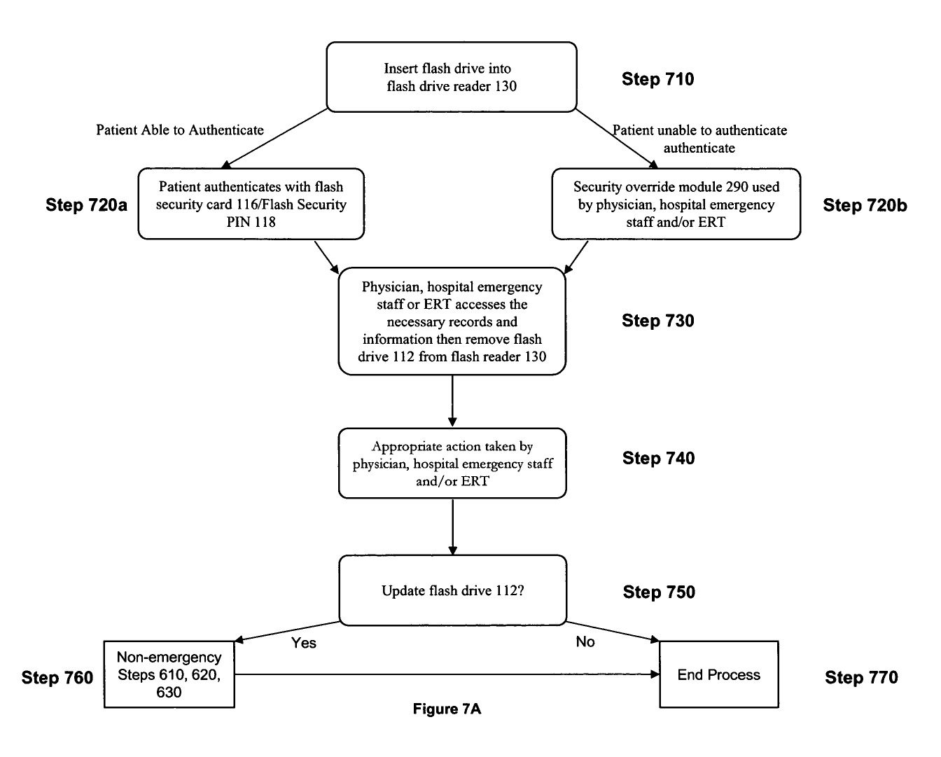

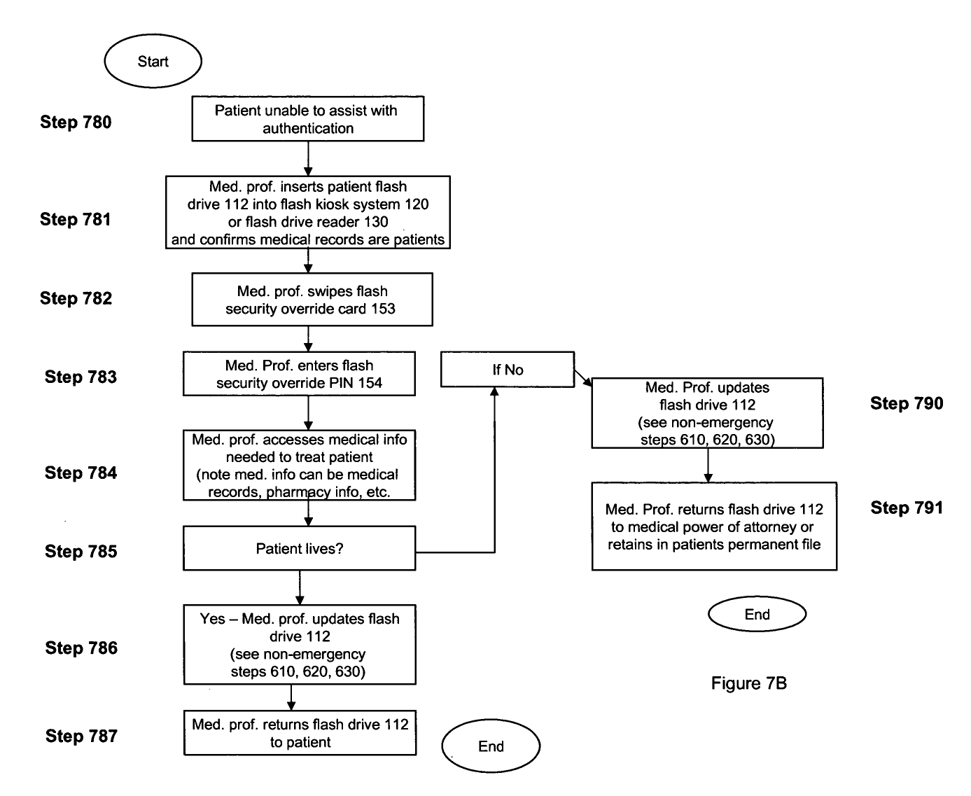

Referring to FIG. 7A, steps of a preferred embodiment for emergency uses 450 are illustrated. In emergency situations, the patient may or may not be able to communicate or perform authentication. Therefore, different procedures can be used for accessing USB flash drive 112 when the patient is able to authenticate versus being unable to authenticate. In an emergency situation, the patient's USB flash drive 112 can be inserted into USB flash drive reader 130 as shown in step 710. Once inserted, a patient able to authenticate through performance or communication can swipe flash security card 116 and enter flash security PIN 118 into USB flash drive reader 130 as shown in step 720a. If the patient is unable to authenticate through performance or communication, then a physician, hospital emergency staff member and/or ERT member can utilize security override module 290 to access USB flash drive 112 as shown in step 720b. This is performed by swiping flash security override card 153 through flash drive reader 130, and entering flash security override PIN 154 into flash drive reader 130. Once accessed, the physician, hospital emergency staff member and/or ERT member accesses the necessary records and information and removes USB flash drive 112 when completed as shown in step 730. The appropriate action can be taken by the physician, hospital emergency staff member and/or ERT to treat the patient as shown in step 740. After treatment, the decision can be made to update USB flash drive 112 as illustrated in step 750. As shown in step 760, if USB flash drive 112 is to be updated, then the patient or authorized person can follow the non-emergency steps 610, 620, 630 of FIG. 6. As shown in step 770, if there are no updates required or desired, then the process can end.

An alternative approach to emergency uses 450 is illustrated in FIG. 7B. Once it is determined that a patient is unable to perform authentication (step 780), the medical professionals (physicians, hospital emergency staff, and/or ERT) insert flash drive 112 into flash kiosk system 120 or flash drive reader 130 and confirms that medical records are the patients (step 781). Then the medical professional swipes flash security override card 153 and enters security override PIN 154 (steps 782 and 783). At this point, the medical professional is authenticated through flash security override module 290 and has access to necessary patient medical records and information on flash drive 112 needed to treat patient (step 784). If the patient survives the emergency, then the medical professional can update flash drive 112 as needed (step 786). Once flash drive 112 is updated, the medical professional returns flash drive 112 to patient or persons authorized to manage the patient's medical crisis. The authorized person should be indicated in the medical information on flash drive 112 in the appropriate modules, such as personal medical information module 270. If the patient does not survive the emergency, the medical professional updates flash drive 112 (step 790), and returns flash drive 112 to medical power of attorney (indicated in personal medical information module 270, for example), or the medical professional retains flash drive 112 in patients permanent file (step 791). It should be realized that flash kiosk system 120 maybe used in emergency situations when available and convenient.

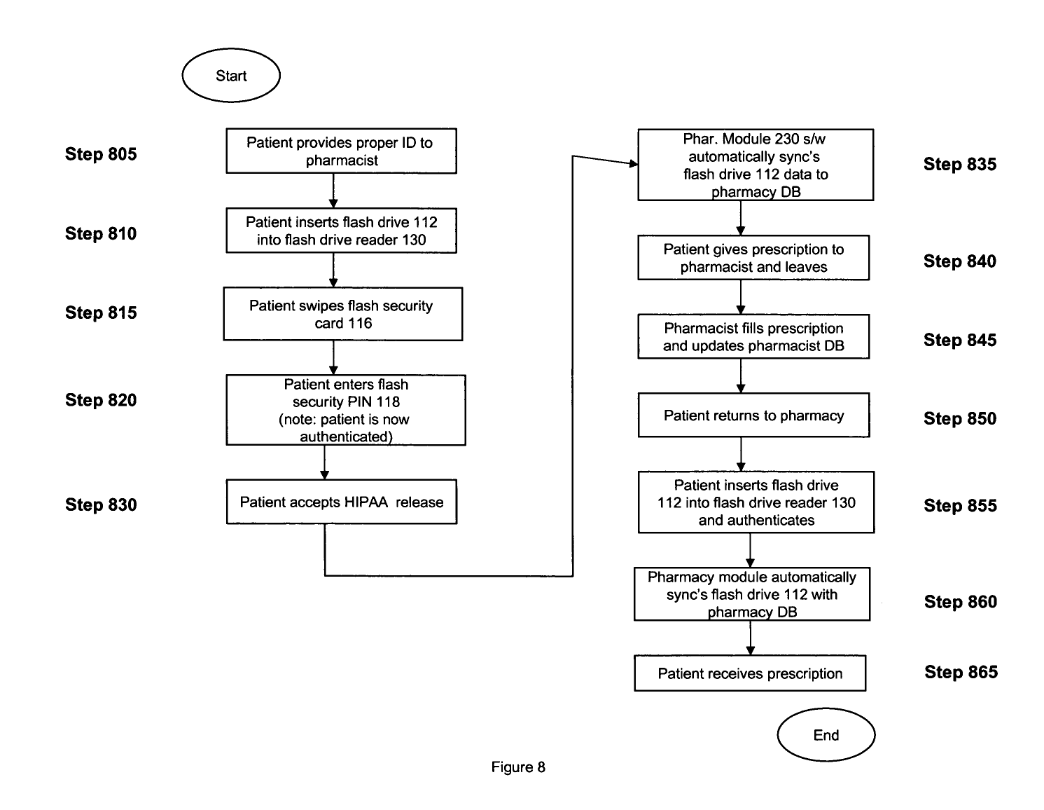

Referring to FIG. 8, steps for a preferred embodiment of pharmacy uses 460 are illustrated. A patient requiring a prescription at a pharmacy preferably provides proper identification to the pharmacy personnel (step 805). The pharmacy personnel preferably provides access to flash drive reader 130, at which time the patient inserts flash drive 112 into flash drive 130 (step 810). Once flash drive 112 is inserted, the patient swipes flash security card 116 (step 815) and enters flash security PIN 118 (step 820). At this time, the patient is authenticated. The patient accepts HIPAA releases from HIPAA releases module 294 (step 830) and proceeds. As a safeguard against fraud, pharmacy module 230 automatically sync's flash drive 112 to the pharmacy database (step 835). The patient gives the prescription to the pharmacist (step 840), and allows the pharmacist to fill the prescription and update the pharmacy database (step 845). The patient returns to the pharmacy or pharmacy counter (step 850) and inserts flash drive 112 into flash drive reader 130 to authenticate (step 855). Then the pharmacy module 230 software automatically sync's flash drive 112 with the pharmacy database (step 860) and the patient receives the filled prescription (step 865) and ends the process.

### VII. Authentication

As described herein, authentication is an integral part of maintaining privacy and security, and to ensuring that HIPAA requirements are met while using universal flash system 100. As will be apparent to one of skill in the art, authentication procedures can vary depending on the system component used and situations in which the system component is used in accordance with the present invention. Table 6 illustrates some non-limiting examples of authentication while working with particular system components that may be a part of universal system 100. These examples and others are discussed in further detail herein above.

TABLE 6
Authentication:

| System Type | Non-Emergency | Emergency |
|---|---|---|
| Flash Kit | CD-ROM on home flash | Preferably not used |
| 110 (home | software system 114 | |
| use) | Insert flash drive 112 | |
| | Enter flash security PIN 118 | |
| Flash Kiosk | Insert flash drive 112 | Preferably not used |
| System 120 | Swipe flash security card 116 | |
| | Enter flash security PIN 118 | |
| Flash Drive | Preferably not used | Insert flash drive 112 |
| Reader 130 | | Medical staff/ERT swipe |
| | | flash security override card |
| | | 153 and enter flash |
| | | security override PIN 154 |
| | | HIPAA releases by patient |
| | | permits access |

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. An universal flash system for managing patient medical records and information comprising:
a portable flash drive adapted to be operatively connected to a computer or flash drive reader, the flash drive being adapted to store a patient set of encrypted medical records and information accessible by the patient and by a third party after authentication.

2. The universal flash system according to claim 1, further comprising:
a patient computer including home flash software for allowing the patient to perform at least one of viewing, accessing and printing the medical records and information.

3. The universal flash system according to claim 1, further comprising a flash drive reader for allowing the third party to access the medical records and information, and wherein authentication includes having at least one of a security card and a personal identification number.

4. The universal flash system according to claim 1, further comprising:
an electronic data management system adapted to compare medical records and information stored on the flash drive to medical records stored not on the flash drive.

5. The universal flash system according to claim 1, further comprising:
an electronic data management system adapted to be interoperable with the flash drive and allow the medical records on the flash drive to be at least one of accessed, updated and downloaded.

6. The universal flash system according to claim 1, wherein the third party is at least one of physician, hospital, emergency response team personnel, and a pharmacist.

7. A portable flash drive for managing a patient's electronic medical records and information, the portable flash drive comprising:
a patient set of electronic medical records stored in a module having a first designated access; and
at least one additional data module having another designated access;
wherein the portable flash drive is operatively adapted to be connected to at least one of a computer, a computer peripheral component and a flash drive reader for accessing said data modules according to designated access.

8. The portable flash drive of claim 7, wherein the data module of i) is adapted to store a patient's electronic medical records received from a data management system maintained by a physician's office or hospital,
whereby the flash drive and data management system are adapted to compare the encrypted medical records on the flash drive to any existing, added or altered medical records in the data management system, and
whereby the flash drive is adapted to share and receive any existing, added or altered medical records to or from the data management system.

9. The portable flash drive of claim 7, wherein the at least one additional data module is adapted to store patient information pertaining to the patient's prescription drugs, medicines, and medical devices for use by the patient, physician, hospital, emergency response team and pharmacy.

10. The portable flash drive of claim 7, wherein the at least one additional data module is adapted to store the patient's emergency contact information for use by the patient, physician, hospital, and emergency response team.

11. The portable flash drive of claim 7, wherein the at least one additional data module is adapted to store personal medical information relating to a patient's allergies, medical conditions, and medical declarations for use by the patient, physician, hospital, and emergency response team.

12. The portable flash drive of claim 7, wherein the at least one additional data module is adapted as a security override module for emergency access to a patient's medical records and information stored on the flash drive for use by a physician, hospital emergency staff and emergency response team.

13. A kit for managing a patient's electronic medical records and information comprising:
i) the portable flash drive of claim 7;
ii) a flash security card adapted to ensure security and authentication when viewing or sharing the patient's medical records at a physician's office, hospital, emergency response team and/or pharmacy,
wherein the security card is swiped through a flash drive reader;
iii) a flash security personal identification number (“PIN”) adapted to be used with the flash security card of i), wherein the PIN is entered into a keypad on the flash drive reader after the flash security card is swiped, or used with a home flash software system; and
iv) the home flash software system of iii) to be installed on the patient's home computer system,
wherein the home flash software system is adapted to interface with the portable flash drive to extract encrypted medical records and patient information in the data modules of the portable flash drive for viewing and printing by the patient,
wherein the home flash software system requires the flash security PIN to access the encrypted medical records and patient information in the data modules of the portable flash drive.

14. The flash drive reader of claim 13, adapted to receive the flash security card for authentication of patient, and having a keypad for entry of the security PIN,
wherein the flash drive reader is adapted to operate as a stand alone device for accessing and viewing patient records on the flash drive, and adapted to be optionally attached to a GUI optionally attached to a data management system in a physician's office, hospital, or pharmacy.

15. The portable flash drive of claim 1, wherein the portable flash drive is an Universal Serial Bus (“USB”) flash drive.

16. The portable flash drive of claim 7, wherein the portable flash drive is an Universal Serial Bus (“USB”) flash drive.

17. The flash drive reader of claim 1, wherein the flash drive reader is an USB flash drive reader.

18. The flash drive reader of claim 7, wherein the flash drive reader is an USB flash drive reader.

19. A method for managing patient medical records and information comprising the step of using the universal flash system of claim 1.
